(19) United States
(12) Patent Application Publication
(10) Pub. No.: US 2026/0161659 A1
(43) Pub. Date: Jun. 11, 2026

(54) Data Structure Format Manipulation for Database Systems

(71) Applicant: Salesforce, Inc., San Francisco, CA (US)

(72) Inventors: Abhijith Anilkumar, San Francisco, CA (US); Douglas Doole, Livermore, CA (US); Rui Zhang, Fremont, CA (US)

(21) Appl. No.: 18/974,318

(22) Filed: Dec. 9, 2024

(51) Int. Cl. G06F 16/25

(52) U.S. Cl. CPC G06F 16/258

(57) ABSTRACT

Techniques are disclosed for dynamically managing data structures during the execution of program instructions in a database system using Just-In-Time (JIT) compilation. A system receives program instructions that include function calls passing data structures as parameters. The system analyzes the call stack associated with the function calls to determine whether to pass the data structure in a first format (e.g., flattened format) or a second format (e.g., expanded format). Based on the analysis, the system inserts bytecode instructions that convert the data structure between formats, depending on whether operations such as write or read are detected. In some embodiments, the system executes the program instructions, including the inserted bytecode, and dynamically converts the data structure from a contiguous block of memory to a non-contiguous block upon detecting modification operations.

### BACKGROUND

### Technical Field

This disclosure relates generally to database systems, and more specifically, to mechanisms for converting data structure formats for a database system.

### Description of the Related Art

In software systems, just-in-time (JIT) compilation plays a role in optimizing the execution of programs by compiling code at runtime. Unlike traditional ahead-of-time compilation, JIT compilation allows for greater flexibility and performance improvements by analyzing program behavior during execution and making adjustments accordingly. This process enables dynamic optimizations, such as inlining functions, eliminating unnecessary operations, or reordering instructions for better execution flow. JIT compilation is particularly beneficial in environments where the workload is unpredictable or varies significantly between program executions, as it can adapt to real-time conditions. As JIT compilers are commonly used in environments such as database systems, gaming engines, and virtual machines, the ability to manage and optimize program execution on-the-fly becomes essential for maintaining performance and resource efficiency, especially in systems that handle large-scale or computationally intensive tasks.

### BRIEF DESCRIPTION OF THE DRAWINGS

FIG. 1 is a block diagram illustrating a system that implements a data structure conversion, according to some embodiments.

FIG. 2 is a block diagram illustrating an example function call stack with inserted operators, according to some embodiments.

FIG. 3 is a block diagram illustrating an example of a flattened data structure and an expanded data structure, according to some embodiments.

FIGS. 4A and 4B are flow diagrams illustrating example methods that implement techniques described herein.

FIG. 5 is a block diagram illustrating one embodiment of an exemplary multi-tenant system for implementing various systems described herein.

### DETAILED DESCRIPTION

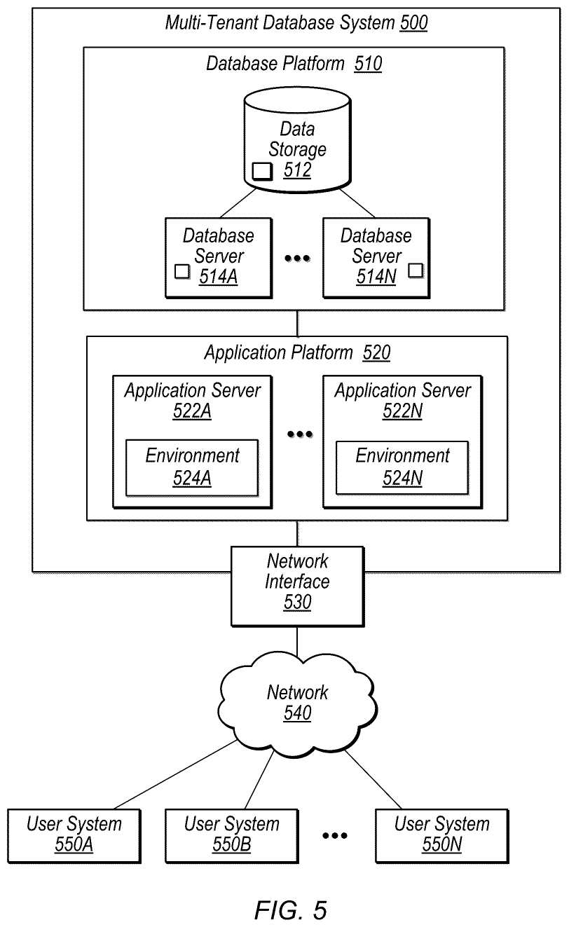

In modern database systems, procedural languages (e.g., PL/pgSQL) and similar languages may play an important role in facilitating operations that interact with the database. In some examples, these procedural languages may work with complex data structures including, but not limited to, arrays and composite types which can be passed between functions as parameters during program execution. In some aspects, to optimize memory usage and execution speed, these data structures may be converted into a flattened format for reading and copying. In some cases, if a function modifies or writes to the data structure, it may be converted into an expanded format which may allow for easier manipulation and updates. In some examples, flattened formats, as described herein, may refer to compact, contiguous memory structures that are efficient for reading and copying, while expanded formats may represent more flexible structures (e.g., using pointers) that may allow easier modification. In various embodiments, a problem arises when data structures are converted between formats which can lead to inefficiencies in memory usage and execution time. By way of example, these repetitive conversions may add overhead to the system such as in large-scale or high-performance environments where function calls and data structures are frequently handled. In some cases, the inefficient handling of data structures may result in higher memory consumption, longer processing times, and a degradation in overall system performance. In large-scale environments, such as multi-tenant databases (e.g., as illustrated in FIG. 5 below) with varying data structures and usage patterns, this problem may become even more pronounced and lead to further performance bottlenecks.

In various embodiments, the present disclosure introduces a method for improving the passing of data structures in procedural languages by leveraging Just-In-Time (JIT) compilation. In some aspects, a system (e.g., multi-tenant database system (MTS) 500) dynamically analyzes the call stack of a program during runtime to determine whether a data structure should be passed in a flattened format or an expanded format. In some cases, the JIT compiler may be responsible for receiving program instructions written in the procedural language and analyzing the associated call stack for each function call to decide how the data structure should be passed. By way of example, if the JIT compiler detects that a function in the call stack will perform read-only operations, the data structure may remain in its flattened format (e.g., which may be more memory-efficient and faster for non-modifying operations). However, in various embodiments, if the JIT compiler identifies that a function will perform write or modification operations, the data structure may be converted into an expanded format before being passed to the function, which may allow for easier manipulation without further format conversions. In some cases, to facilitate this process, the JIT compiler may insert operators (or bytecode instructions) into the program instructions such that the data structures are converted to the correct format at the appropriate time. These operators may act as instructions for converting the data structure such that it is passed in the correct format between functions.

In some embodiments, the system's approach provides several advantages by addressing the inefficiencies of traditional data structure handling in procedural languages. For example, one benefit may be the reduction of unnecessary format conversions as the JIT compiler only converts data structures to the expanded format when modifications are needed, which may potentially reduce memory allocation overhead. This may lead to faster processing and lower memory usage such as when handling large data sets. In some instances, execution speed may be enhanced by keeping data structures in a flattened format for read-only operations, which may allow for faster access to contiguous blocks of memory. The system may also improve scalability in high-performance environments such as multi-tenant databases (e.g., multi-tenant database 500) where dynamic workloads and varying data structures may demand efficient memory management. By dynamically analyzing the call stack and determining the optimal format for data structures, the system may provide consistent performance across different environments. In some examples, the JIT compiler may insert operators to manage memory including deleting data structures when they are no longer needed (e.g., which may prevent memory leaks and optimize system resources). In some embodiments, this dynamic method of handling data structures may result in improved memory efficiency, execution speed, and overall system scalability.

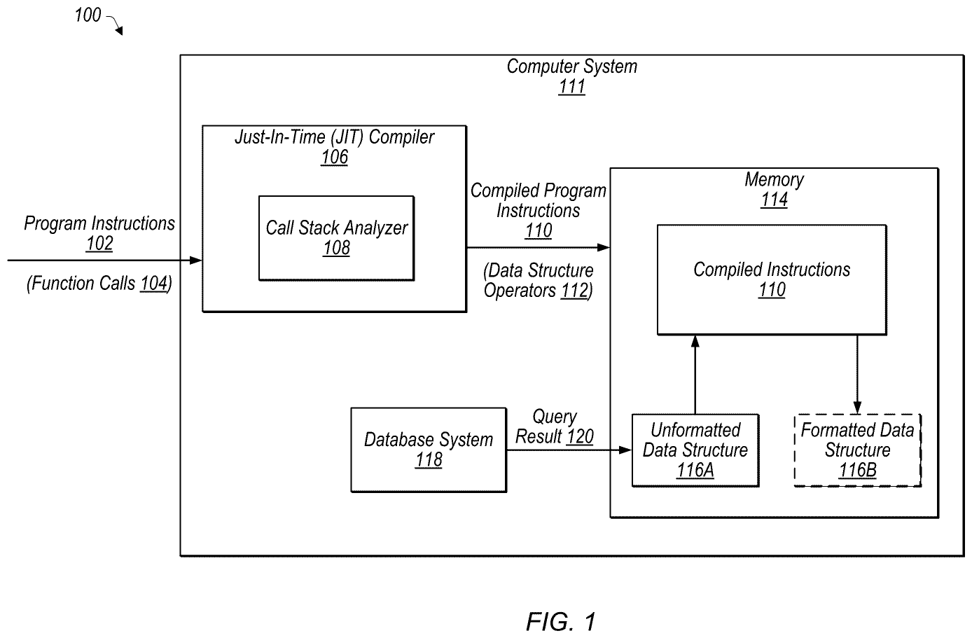

Turning now to FIG. 1, a block diagram of a system 100 that implements a data structure conversion is depicted. In the illustrated embodiment, computer system 111 includes several components, including Just-In-Time (JIT) compiler 106, memory 114, and database system 118. In some embodiments, system 100 optimizes the handling of data structures 116 during the execution of program instructions that involve various function calls. For example, system 100 may dynamically convert data structures 116 between different formats (e.g., unformatted data structure 116A and formatted data structure 116B) depending on the operations being performed on the data. In some embodiments, in order to identify the operations that will be performed on data structure 116, system 100 may construct a syntax tree, which may provide a hierarchical representation of function calls 104 and the operations they perform. The syntax tree may identify whether each function performs a read or write operation on the data structure, which may help system 100 determine whether to keep data structure 116 in its flattened format (e.g., unformatted data structure 116A) or convert it to an expanded format (e.g., formatted data structure 116B).

In some embodiments, computer system 111 is implemented as part of a distributed computing environment. For example, computer system 111 may be deployed on a cloud-based infrastructure including, but not limited to, Amazon® Web Services (AWS), Microsoft® Azure, or Google® Cloud, enabling users to provision resources such as memory 114, processing power, and database systems 118 based on workload requirements. In some cases, this cloud-based infrastructure may allow computer system 111 to scale dynamically and allocate resources as needed. Additionally, in some embodiments, computer system 111 may be distributed across multiple physical computing systems, including different geographic locations or availability zones (AZs). In some aspects, this setup may enable computer system 111 to manage large-scale data operations across multiple servers, providing high scalability, fault tolerance, and resilience. In other cases, computer system 111 may be implemented on a local or private infrastructure rather than a public cloud, depending on deployment requirements.

In some embodiments, program instructions 102 may include procedural language instructions (e.g., PL/pgSQL or other similar languages) which are received by JIT compiler 106. Program instructions 102 may include function calls 104, which may represent the relationships between the functions to be executed. By way of example, if a first function calls a second function, and that second function calls a third, these may be stacked as a sequence of function calls 104 known as a call stack. The syntax tree that may be constructed by system 100 (e.g., during compilation) may provide a detailed representation of these function calls 104 and their relationships. By analyzing the syntax tree, system 100 may determine whether a given function call 104 involves a read or write operation on data structure 116. In some examples, the call stack may represent the order in which functions are invoked within the program, and each function call 104 may potentially impact how data structures 116 are processed.

In some instances, JIT compiler 106 may be responsible for compiling program instructions 102 and analyzing the call stack. In some embodiments, JIT compiler 106 includes call stack analyzer 108, which may examine each function call 104 in the call stack to determine the type of operations that will be performed on data structures 116 (e.g., unformatted data structure 116A, formatted data structure 116B). By leveraging a syntax tree, call stack analyzer 108 may track each function call 104 and identify whether each function performs a read or write operation on data structure 116. For example, if function calls 104 indicate that a read-only operation will be performed, JIT compiler 106 may allow data structures 116 to remain in a compact, memory-efficient format known as the flattened format (e.g., unformatted data structure 116A). In some aspects, if function calls 104 require modifications (e.g., a write operation), JIT compiler 106 may prepare data structures 116 for conversion into an expanded format (e.g., formatted data structure 116B) which may allow for more flexible manipulation of the data. In some embodiments, call stack analyzer 108 plays a role in identifying which functions will modify data structures 116 and determine whether certain operators 112 need to be inserted to handle these changes.

In some examples, after the analysis is complete, JIT compiler 106 may generate compiled program instructions 110, which may be the result of compiling original program instructions 102. In some embodiments, compiled instructions 110 include data structure operators 112, which may be responsible for dynamically converting data structures 116 between the flattened (e.g., unformatted data structure 116A) and expanded formats (e.g., formatted data structure 116B) during execution. In some cases, operators 112 may allow data structures 116 to be passed in the correct format as they move through function calls 104. In some examples, compiled instructions 110 are stored in memory 114 for execution.

In some embodiments, memory 114 in computer system 111 stores both compiled program instructions 110 and data structures 116 that may be either unformatted 116A or formatted 116B. For example, unformatted data structure 116A may refer to the flattened format of the data (e.g., which may be compact and memory-efficient; an array of elements where each element is stored in a contiguous block of memory). In some cases, the flattened format may be used when the data is read-only or when no modifications are required. In some cases, formatted data structure 116B may refer to the expanded format (e.g., which may be more flexible and suitable for modification). In some aspects, during the execution of compiled instructions 110, system 100 may pull an unformatted data structure 116A from memory 114, and if necessary, data structure operators 112 embedded in compiled instructions 110 may convert it into a formatted data structure 116B. This conversion may occur when the program performs operations that modify the data (e.g., a write operation).

In some embodiments, data retrieved from database system 118 may be initially stored in memory 114 as an unformatted data structure 116A (e.g., in its flattened format). For example, a query issued by compiled program instructions 110 may retrieve data from database system 118 referred to as query result 120, which may then be processed by compiled instructions 110 stored in memory 114. Depending on the nature of function calls 104, the data may either remain in its flattened format or be converted to an expanded format (e.g., formatted data structure 116B) to accommodate any modifications (e.g., write operations). In some cases, once the modifications are complete, system 100 may write formatted data structure 116B back to memory 114 or even back into the database system 118.

In some embodiments, the dynamic management of data structure 116 formats by compiled instructions 110 is important for optimizing both memory usage and execution speed. If call stack analyzer 108 determines that data structure 116 will only undergo read operations, data structure 116 may remain in its flattened format (e.g., unformatted data structure 116A). However, if system 100 detects a write or modification operation, data structure operators 112 may convert unformatted data structure 116A into the expanded format (e.g., formatted data structure) 116B.

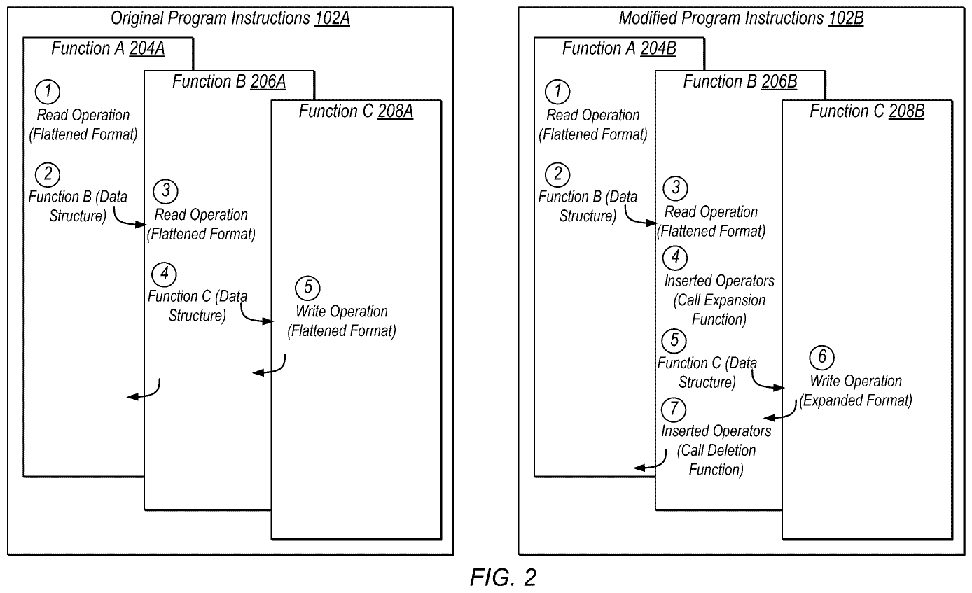

Turning now to FIG. 2, a block diagram illustrating an example function call stack with inserted operators is shown. In the illustrated embodiment of FIG. 2, original program instructions 102A (e.g., program instructions 102 as discussed above with respect to FIG. 1) include function calls (e.g., function calls 104) without operators, and modified program instructions 102B include function calls with inserted operators (e.g., data structure operators 112).

In some embodiments, original program instructions 102A (e.g., program instructions 102, compiled program instructions 110) include one or more functions (e.g., function A 204A, function B 206A, function C 208A, etc.) which may be included in a call stack as discussed above with respect to FIG. 1. In step 1, function A 204A may perform a read operation on a data structure, which may be stored in a flattened format (e.g., unformatted data structure 116A). Next, in step 2, function A 204A may call function B 206A (e.g., as indicated by the call stack) and pass the data structure in its flattened format as a parameter. In step 3, function B 206A may perform another read operation on the data structure, which may remain in its flattened format. Subsequently, in step 4, function B 206A may call function C 208A, again passing the data structure in its flattened format. In Step 5, function C 208A may perform a write operation on the data structure while it is still in the flattened format. The return arrows from function C 208A to function B 206A, and from function B 206A to function A 204A may represent the typical automatic return function calls when functions complete their execution. In the illustrated embodiment of FIG. 2, original program instructions 102A show the write operation in step 5 operating on the flattened format of the data structure, which may be less efficient when data modifications are necessary.

In some embodiments, modified program instructions 102B include inserted operators that optimize the data structure format for write operations (e.g., via utilizing an expanded format compared to a flattened format as shown in original program instructions 102A). Similar to original program instructions 102A, step 1 and step 2 involve function A 204B performing a read operation on the flattened data structure and subsequently calling function B 206B, passing the data structure in its flattened format. In step 3, function B 206B may perform another read operation on the data structure, again while it is still in its flattened format. In some embodiments, at this point, the system (e.g., system 100) may recognize that function C 208B will perform a write operation (e.g., in step 6), which may require the data structure to be in an expanded format.

In some aspects, in step 4, the system (e.g., system 100) may insert operators into function B 206B to invoke an expansion function, which may convert the data structure from its flattened format to its expanded format. These operators may call an expansion function directly included in function B 206B, or in various embodiments, may involve calling an external function (e.g., external to function B 206B) that may be responsible for performing the format conversion from the flattened to expanded format. Once the conversion is completed, the data structure may be in its expanded format, allowing function C 208B to modify it during the write operation in step 6.

After the write operation is completed in function C 208B in step 6, the system may return to function B 206B. In some embodiments, in step 7, the system may insert additional operators to invoke a deletion function if the data structure is no longer needed. Similar to the expansion function, in various embodiments, the deletion function may reside within function B 206B or be an external function. For example, this step may allow for efficient memory usage by cleaning up the expanded data structure once it is no longer in use. After completing these operations, the program may return to function A 204B as represented by the return arrows.

In some embodiments, a primary difference between original program instructions 102A and modified program instructions 102B is the use of inserted operators to dynamically change the data structure's format based on the nature of the function calls. In the original approach, the data structure may, at each function boundary, be converted from a flattened format to an expanded format and back to its flattened format, regardless of whether write operations may exist in the next function referenced by the function call. Furthermore, the data structure is passed by value (i.e., copied/duplicated) at each function boundary. This may lead to potential inefficiencies. In contrast, modified instructions 102B may use operators to detect when a write operation will occur and convert the data structure to an expanded format before modification. The data structure is further passed by reference (i.e., not copied) at each function boundary allowing the called function to operate on the same data structure (as opposed to a duplicated one) as the previous function that called it. In some cases, once the expanded format is no longer necessary, the system may clean up the data structure through a deletion function, thereby potentially optimizing both memory usage and execution performance.

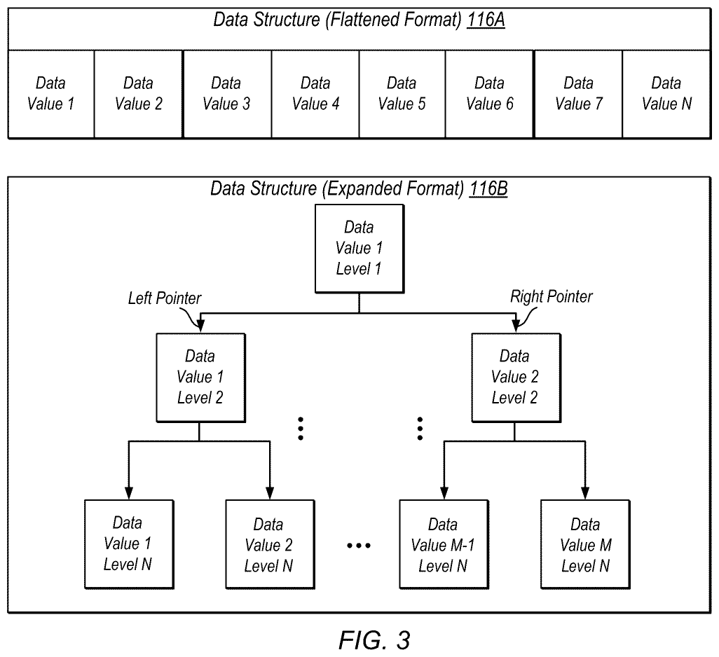

Turning now to FIG. 3, a block diagram illustrating an example of a flattened data structure 116A (e.g., unformatted data structure 116A as illustrated in FIG. 1) and an expanded data structure 116B (e.g., formatted data structure 116B as illustrated in FIG. 1) is shown. In the illustrated embodiment of FIG. 3, flattened data structure 116A may represent a contiguous block of memory where data values are stored sequentially, and expanded data structure 116B may be represented as a tree structure where data values are distributed across multiple levels, with pointers linking each node.

In some examples, flattened data structure 116A may comprise N data values (e.g., labeled data value 1, data value 2, through data value N representing N number of data values). By way of example, each data value may represent a segment of memory with the data stored contiguously (e.g., in a contiguous block of memory). For example, this may represent an array of bytes where each byte is 8 bits, and the entire array is stored in a continuous block of memory. In some cases, flattened format 116A may be memory-efficient for read operations, as all the data values may be located sequentially, which may allow the system (e.g., system 100) to quickly access any value in the structure by calculating the appropriate offset.

In some embodiments, flattened format 116A may potentially be useful when no modifications (e.g., write operations) are needed or when the data is primarily read-only. Since all data values may be stored in one continuous block, flattened format 116A may minimize memory fragmentation and allow for efficient memory access. However, in some cases, the downside to flattened format 116A is that if modifications or dynamic adjustments (e.g., insertions or deletions) are needed, the entire structure may need to be rearranged or rewritten, which may lead to inefficiencies in scenarios where frequent updates are needed.

In some embodiments, expanded data structure 116B may be represented as a tree data structure which may be a non-contiguous block of memory. By way of example, at the top of the tree may be the root node, labeled as data value 1 at level 1. In some examples, this node may contain the primary data value along with pointers (labeled as left pointer and right pointer) that point to the subsequent nodes in the tree. In some aspects, each node in the tree may consist of the data value and its associated pointers, which may indicate the memory locations of the next elements in the tree. For example, data value 1 at level 2 is shown on the left side of the tree, and data value 2 at level 2 is shown on the right side. These nodes may be connected to the root node via their respective pointers.

In some cases, expanded format 116B may provide flexibility and be well-suited for cases where frequent modifications are necessary. Since each node in the tree may be connected via pointers, the data structure 116B may easily be updated without requiring a full reorganization of the memory block. For example, to modify data value 1 at level 2, the system may only need to update the specific node, which may leave the rest of the tree intact. Additionally, as the tree grows deeper (e.g., as shown by N levels in the vertical direction), it may accommodate N levels of data (e.g., represented by the sequence of dots). For instance, at the Nth level of the tree, there is data value 1 at level N and data value 2 at level N on the left side of the tree. Furthermore, the tree structure may also support multiple data values at each level. On the right side of the tree, there is data value M−1 at level N and data value M at level N, indicating that the structure may hold M number of data values at the Nth level. This may allow the tree to scale both vertically (i.e., with additional levels) and horizontally (i.e., with multiple data values per level). The ability to store data in a non-contiguous fashion (e.g., using pointers to link nodes) may allow for more dynamic memory management (e.g., in scenarios where the size of the data set may change frequently).

In some embodiments, a difference between flattened format 116A and expanded format 116B may be in the way data is stored and accessed. For example, in some cases, while flattened format 116A may be efficient for reading contiguous blocks of memory, it may be less flexible when it comes to modifications or dynamic changes to data structure 116. In contrast, expanded format 116B may provide greater flexibility, as each node may be connected via pointers, which may allow for more efficient modifications and updates. However, in some cases, this flexibility may come at the cost of increased memory usage, as each node may need to store not only the data but also the associated pointers.

In some embodiments, expanded data structure 116B may utilize other non-contiguous data structures including, but not limited to, linked lists, graphs, or hash tables, depending on the use case. Those skilled in the art will appreciate additional examples of representing expanded data structure 116B and data structure 116A.

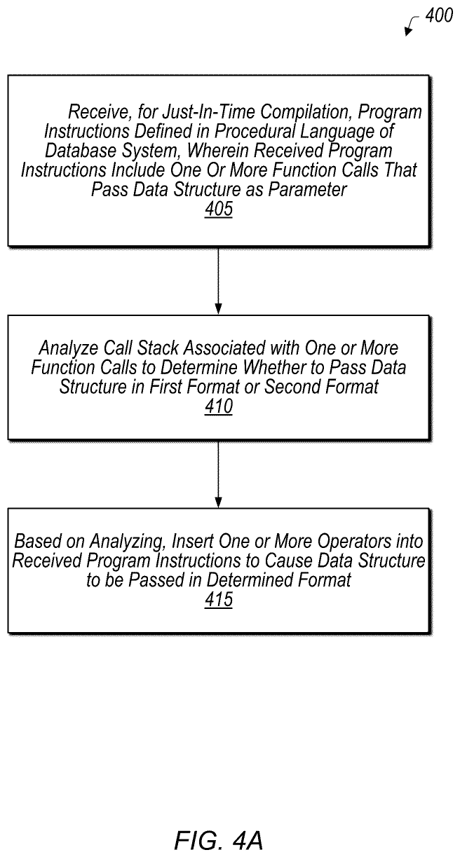

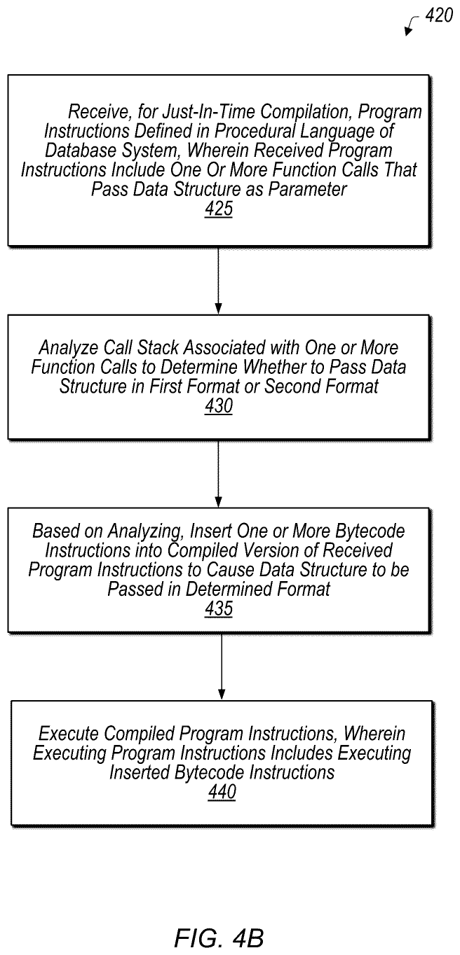

Turning now to FIG. 4A, a flow diagram of a method 400 is shown. Method 400 is one embodiment of a method that is performed by a computing system implements a data structure conversion such as system 100. In various embodiments, method 400 may be performed by executing program instructions stored on a non-transitory computer-readable storage medium. In some embodiments, method 400 includes more or fewer steps than shown.

Method 400 begins in step 405 with the computing system receiving, for just-in-time compilation, program instructions defined in a procedural language of a database system. For example, JIT compiler 106 may receive program instructions 102, which may include one or more function calls 104 that pass a data structure as a parameter. These program instructions may be part of a procedural language (e.g., such as PL/pgSQL), and the received program instructions may involve interactions with various data structures stored within database system 118. In some embodiments, the received program instructions include one or more function calls that pass a data structure as a parameter. For example, function calls 104 within the received program instructions 102 may pass a data structure 116 as a parameter between different functions. These function calls may be part of a sequence within a call stack, where the data structure may be passed either in its flattened format (e.g., unformatted data structure 116A) or expanded format (e.g., formatted data structure 116B), depending on the operations performed by each function.

In step 410, the computer system analyzes a call stack associated with the one or more function calls to determine whether to pass the data structure in a first format or a second format. For example, call stack analyzer 108 within JIT compiler 106 may analyze the sequence of function calls 104 within the call stack to determine whether the data structure 116 should remain in its flattened format (e.g., unformatted data structure 116A) or be converted to an expanded format (e.g., formatted data structure 116B). This determination may be based on whether the upcoming functions will perform read-only operations or write operations on the data structure.

In step 415, the computer system, based on the analyzing, inserts one or more operators into the received program instructions to cause the data structure to be passed in the determined format. For example, JIT compiler 106, after analyzing the call stack through call stack analyzer 108, may insert one or more data structure operators 112 into program instructions 102. These operators may convert data structure 116 between a flattened format (e.g., unformatted data structure 116A) and an expanded format (e.g., formatted data structure 116B) depending on whether a read or write operation is expected in the upcoming function calls.

In various embodiments, the analyzing further comprises building a syntax tree, wherein the syntax tree identifies for each of the one or more function calls whether that function performs read or write operations on the data structure and examining the read and write operations identified in the syntax tree. For example, call stack analyzer 108 may generate a syntax tree that provides a hierarchical representation of function calls 104. The syntax tree may track whether each function performs a read or write operation on data structure 116. This may enable the system to make informed decisions about whether the data structure should remain in the flattened format (116A) or be converted to the expanded format (116B), based on the detected operations in the call stack.

In various embodiments, method 400 further includes the computer system, after compilation of the received program instructions, executing the compiled program instructions. For example, the database execution engine of database system 118 may execute compiled program instructions 110, including the inserted data structure operators 112. In some cases, executing the program instructions includes executing the one or more operators to cause the data structure to be passed in the determined format. For example, these operators may dynamically manage the conversion of data structure 116 between its flattened format (e.g., unformatted data structure 116A) and its expanded format (e.g., formatted data structure 116B) during execution. This may enable the data structure to be passed in the correct format between function calls 104, depending on the nature of the operations performed by each function in the call stack.

In some embodiments, the one or more operators inserted include an operator that deletes the data structure after determining, based on the call stack, that the data structure is no longer needed. For example, after analyzing the call stack via call stack analyzer 108, JIT compiler 106 may insert a deletion operator (e.g., data structure operators 112) into program instructions 110. This deletion operator may trigger the removal of data structure 116 from memory 114 once it is determined that no subsequent function in the call stack will perform further operations on data structure 116. This may help free up memory resources and prevent memory leaks in scenarios where data structure 116 is no longer required after certain function calls 104.

In some embodiments, the first format is a flattened format and the second format is an expanded format, and wherein the one or more operators inserted into the received program instructions convert the data structure from the flattened format to the expanded format upon detecting a write operation in a subsequent function call. For example, JIT compiler 106, after analyzing the call stack, may insert data structure operators 112 that convert data structure 116 from a flattened format (e.g., unformatted data structure 116A) to an expanded format (e.g., formatted data structure 116B). This conversion may be triggered when call stack analyzer 108 detects a write operation in a subsequent function call 104, indicating that data structure 116 will need to be modified, which may require the expanded format for data manipulation.

In some embodiments, the conversion of the data structure from the flattened format to the expanded format is performed by calling an expansion function that executes the conversion prior to a transition between function calls. For example, as illustrated in FIG. 2, JIT compiler 106 may insert an expansion function (e.g., step 4 in function B 206B) into the program instructions 110 as part of data structure operators 112. This expansion function may be called before the system transitions between function calls 104 (e.g., between function B 206B and function C 208B), allowing data structure 116 to be converted from its flattened format (e.g., unformatted data structure 116A) to its expanded format (e.g., formatted data structure 116B) prior to executing the subsequent function that performs a write operation.

In some embodiments, the flattened format stores the data structure in a contiguous block of memory, and wherein the expanded format stores the data structure in a tree structure using pointers to one or more memory locations. For example, as illustrated in FIG. 3, flattened format 116A may store data structure 116 as a contiguous block of memory, where each data value is sequentially placed in memory. In contrast, expanded format 116B may be represented as a tree structure, where each node contains data and pointers (e.g., left pointer and right pointer) that point to the next memory locations at various levels of the tree. In some cases, a tree structure allows data structure 116 to be stored in non-contiguous memory locations (e.g., which may provide flexibility for dynamic modifications).

Turning now to FIG. 4B, a flow diagram of a method 420 is shown. Method 420 is one embodiment of a method that is performed by a computing system implements a data structure conversion such as system 100. In various embodiments, method 420 may be performed by executing program instructions stored on a non-transitory computer-readable storage medium. In some embodiments, method 400 includes more or fewer steps than shown.

In the illustrated embodiment of FIG. 4B, steps 425, 430, and 440 are as described above with respect to steps 405, 410, and 415 in FIG. 4A. In some cases, the term bytecode instructions may be used instead of operators. These bytecode instructions may perform similar functions, such as dynamically converting data structure 116 between its flattened and expanded formats or managing memory operations like deletions.

In step 440, the computer system executes the program instructions. For example, JIT compiler 106 may execute compiled program instructions 110, which may include the inserted bytecode instructions. In some embodiments, executing program instructions 110 includes executing the inserted bytecode instructions during the just-in-time compilation process. For example, these bytecode instructions may manage the conversion of data structure 116 between its flattened format (e.g., unformatted data structure 116A) and its expanded format (e.g., formatted data structure 116B) as needed. The bytecode instructions may also handle memory operations, such as deleting data structures that are no longer required, during the execution of function calls 104.

In some embodiments, method 420 further includes steps for determining, based on a return from a function call, that no subsequent function in the call stack performs a read or write operation on the data structure and inserting a deletion operation within the bytecode instructions that deletes the data structure. For example, after analyzing the return from a function call via call stack analyzer 108, the system may detect that no further read or write operations will be performed on data structure 116. In such cases, the bytecode instructions inserted by JIT compiler 106 may include a deletion operation that removes data structure 116 from memory 114 (e.g., which may free up system resources and prevent potential memory leaks).

In some embodiments, the first format is a contiguous block of memory and the second format is a non-contiguous block of memory, and wherein the one or more operators inserted into the compiled program instructions convert the data structure from the contiguous block of memory to the non-contiguous block of memory upon detecting a write operation in a subsequent function call. For example, JIT compiler 106 may insert data structure operators 112 that convert data structure 116 from a contiguous block of memory (e.g., flattened format) to a non-contiguous block of memory (e.g., expanded format). In some instances, this conversion may be triggered when call stack analyzer 108 detects a write operation in a subsequent function call 104, which may require the data structure to be in a non-contiguous format (e.g., using pointers) to allow for more flexible modifications, as illustrated in FIG. 3.

In some embodiments, first format of the data structure is a flattened format represented as an array of elements. For example, data structure 116 in its flattened format (e.g., unformatted data structure 116A) may be represented as an array of elements, where each element may be stored in a contiguous block of memory. This array may contain multiple data values that are sequentially arranged in memory, which may provide access for read operations, as shown in FIG. 3, where flattened format 116A may represent a contiguous array structure.

In some embodiments, the first format is a flattened format and the second format is an expanded format, and wherein the data structure is passed by reference between function calls in the flattened format if a write operation is not detected. For example, data structure 116 may be passed in its flattened format (e.g., unformatted data structure 116A) by reference between function calls 104 if call stack analyzer 108 does not detect a write operation. In this example, the data structure may remain in its compact, memory-efficient flattened format, which may reduce the overhead of unnecessary conversions. However, if a write operation is detected, the data structure may be converted to the expanded format (e.g., formatted data structure 116B) to accommodate modifications.

### Exemplary Multi-tenant Database System

Turning now to FIG. 5, an exemplary multi-tenant database system (MTS) 500, which may implement functionality of system 100 as illustrated above with respect to FIG. 1, is depicted. In the illustrated embodiment, MTS 500 includes a database platform 510, an application platform 520, and a network interface 530 connected to a network 540. Database platform 510 includes a data storage 512 and a set of database servers 514A-N that interact with data storage 512, and application platform 520 includes a set of application servers 522A-N having respective environments 524. In the illustrated embodiment, MTS 500 is connected to various user systems 550A-N through network 540. In other embodiments, techniques of this disclosure are implemented in non-multi-tenant environments such as client/server environments, cloud computing environments, clustered computers, etc.

MTS 500, in various embodiments, is a set of computer systems that together provide various services to users (or sets of users alternatively referred to as “tenants”) that interact with MTS 500. In some embodiments, MTS 500 implements a customer relationship management (CRM) system that provides mechanism for tenants (e.g., companies, government bodies, etc.) to manage their relationships and interactions with customers and potential customers. For example, MTS 500 might enable tenants to store customer contact information (e.g., a customer's website, email address, telephone number, and social media data), identify sales opportunities, record service issues, and manage marketing campaigns. Furthermore, MTS 500 may enable those tenants to identify how customers have been communicated with, what the customers have bought, when the customers last purchased items, and what the customers paid. To provide the services of a CRM system and/or other services, as shown, MTS 500 includes a database platform 510 and an application platform 520.

Database platform 510, in various embodiments, is a combination of hardware elements and software routines that implement database services for storing and managing data of MTS 500, including tenant data. As shown, database platform 510 includes data storage 512. Data storage 512, in various embodiments, includes a set of storage devices (e.g., solid state drives, hard disk drives, etc.) that are connected together on a network (e.g., a storage attached network (SAN)) and configured to redundantly store data to prevent data loss. Data storage 512 may implement a single database, a distributed database, a collection of distributed databases, a database with redundant online or offline backups or other redundancies, etc.

In various embodiments, a database record may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 500 may store, in the same table, database records for one or more tenants-that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, data storage 512 is organized as part of a log-structured merge-tree (LSM tree). As noted above, a database server 514 may initially write database records into a local in-memory buffer data structure before later flushing those records to the persistent storage (e.g., in data storage 512). As part of flushing database records, the database server 514 may write the database records into new files/extents that are included in a “top” level of the LSM tree. Over time, the database records may be rewritten by database servers 514 into new files included in lower levels as the database records are moved down the levels of the LSM tree. In various implementations, as database records age and are moved down the LSM tree, they are moved to slower and slower storage devices (e.g., from a solid-state drive to a hard disk drive) of data storage 512.

When a database server 514 wishes to access a database record for a particular key, the database server 514 may traverse the different levels of the LSM tree for files that potentially include a database record for that particular key. If the database server 514 determines that a file may include a relevant database record, the database server 514 may fetch the file from data storage 512 into a memory of the database server 514. The database server 514 may then check the fetched file for a database record having the particular key. In various embodiments, database records are immutable once written to data storage 512. Accordingly, if the database server 514 wishes to modify the value of a row of a table (which may be identified from the accessed database record), the database server 514 writes out a new database record into the buffer data structure, which is purged to the top level of the LSM tree. Over time, that database record is merged down the levels of the LSM tree. Accordingly, the LSM tree may store various database records for a database key such that the older database records for that key are located in lower levels of the LSM tree then newer database records.

Database servers 514, in various embodiments, are hardware elements, software routines, or a combination thereof capable of providing database services, such as data storage, data retrieval, and/or data manipulation Such database services may be provided by database servers 514 to components (e.g., application servers 522) within MTS 500 and to components external to MTS 500. As an example, a database server 514 may receive a database transaction request from an application server 522 that is requesting data to be written to or read from data storage 512. The database transaction request may specify an SQL SELECT command to select one or more rows from one or more database tables. The contents of a row may be defined in a database record and thus database server 514 may locate and return one or more database records that correspond to the selected one or more table rows. In various cases, the database transaction request may instruct database server 514 to write one or more database records for the LSM tree-database servers 514 maintain the LSM tree implemented on database platform 510. In some embodiments, database servers 514 implement a relational database management system (RDMS) or object-oriented database management system (OODBMS) that facilitates storage and retrieval of information against data storage 512. In various cases, database servers 514 may communicate with each other to facilitate the processing of transactions. For example, database server 514A may communicate with database server 514N to determine if database server 514N has written a database record into its in-memory buffer for a particular key.

Application platform 520, in various embodiments, is a combination of hardware elements and software routines that implement and execute CRM software applications as well as provide related data, code, forms, web pages and other information to and from user systems 550 and store related data, objects, web page content, and other tenant information via database platform 510. In order to facilitate these services, in various embodiments, application platform 520 communicates with database platform 510 to store, access, and manipulate data. In some instances, application platform 520 may communicate with database platform 510 via different network connections. For example, one application server 522 may be coupled via a local area network and another application server 522 may be coupled via a direct network link. Transfer Control Protocol and Internet Protocol (TCP/IP) are exemplary protocols for communicating between application platform 520 and database platform 510, however, it will be apparent to those skilled in the art that other transport protocols may be used depending on the network interconnect used.

Application servers 522, in various embodiments, are hardware elements, software routines, or a combination thereof capable of providing services of application platform 520, including processing requests received from tenants of MTS 500. Application servers 522, in various embodiments, can spawn environments 524 that are usable for various purposes, such as providing functionality for developers to develop, execute, and manage applications. Data may be transferred into an environment 524 from another environment 524 and/or from database platform 510. In some cases, environments 524 cannot access data from other environments 524 unless such data is expressly shared. In some embodiments, multiple environments 524 can be associated with a single tenant.

Application platform 520 may provide user systems 550 access to multiple, different hosted (standard and/or custom) applications, including a CRM application and/or applications developed by tenants. In various embodiments, application platform 520 may manage creation of the applications, testing of the applications, storage of the applications into database objects at data storage 512, execution of the applications in an environment 524 (e.g., a virtual machine of a process space), or any combination thereof. In some embodiments, application platform 520 may add and remove application servers 522 from a server pool at any time for any reason, there may be no server affinity for a user and/or organization to a specific application server 522. In some embodiments, an interface system (not shown) implementing a load balancing function (e.g., an F6 Big-IP load balancer) is located between the application servers 522 and the user systems 550 and is configured to distribute requests to the application servers 522. In some embodiments, the load balancer uses a least connections algorithm to route user requests to the application servers 522. Other examples of load balancing algorithms, such as are round robin and observed response time, also can be used. For example, in certain embodiments, three consecutive requests from the same user could hit three different servers 522, and three requests from different users could hit the same server 522.

In some embodiments, MTS 500 provides security mechanisms, such as encryption, to keep each tenant's data separate unless the data is shared. If more than one server 514 or 522 is used, they may be located in close proximity to one another (e.g., in a server farm located in a single building or campus), or they may be distributed at locations remote from one another (e.g., one or more servers 514 located in city A and one or more servers 522 located in city B). Accordingly, MTS 500 may include one or more logically and/or physically connected servers distributed locally or across one or more geographic locations.

One or more users (e.g., via user systems 550) may interact with MTS 500 via network 540. User system 550 may correspond to, for example, a tenant of MTS 500, a provider (e.g., an administrator) of MTS 500, or a third party. Each user system 550 may be a desktop personal computer, workstation, laptop, PDA, cell phone, or any Wireless Access Protocol (WAP) enabled device or any other computing device capable of interfacing directly or indirectly to the Internet or other network connection. User system 550 may include dedicated hardware configured to interface with MTS 500 over network 540. User system 550 may execute a graphical user interface (GUI) corresponding to MTS 500, an HTTP client (e.g., a browsing program, such as Microsoft's Internet Explorer™ browser, Netscape's Navigator™ browser, Opera's browser, or a WAP-enabled browser in the case of a cell phone, PDA or other wireless device, or the like), or both, allowing a user (e.g., subscriber of a CRM system) of user system 550 to access, process, and view information and pages available to it from MTS 500 over network 540. Each user system 550 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 500 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 550 may be users in differing capacities, the capacity of a particular user system 550 might be determined one or more permission levels associated with the current user. For example, when a salesperson is using a particular user system 550 to interact with MTS 500, that user system 550 may have capacities (e.g., user privileges) allotted to that salesperson. But when an administrator is using the same user system 550 to interact with MTS 500, the user system 550 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 500 that are allocated at the tenant level while other data structures are managed at the user level.

In some embodiments, a user system 550 and its components are configurable using applications, such as a browser, that include computer code executable on one or more processing elements. Similarly, in some embodiments, MTS 500 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 540 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 550 may communicate with MTS 500 using TCP/IP and, at a higher network level, use other common Internet protocols to communicate, such as HTTP, FTP, AFS, WAP, etc. For example, where HTTP is used, user system 550 might include an HTTP client commonly referred to as a “browser” for sending and receiving HTTP messages from an HTTP server at MTS 500. Such a server might be implemented as the sole network interface between MTS 500 and network 540, but other techniques might be used as well or instead. In some implementations, the interface between MTS 500 and network 540 includes load sharing functionality, such as round-robin HTTP request distributors to balance loads and distribute incoming HTTP requests evenly over a plurality of servers.

In various embodiments, user systems 550 communicate with application servers 522 to request and update system-level and tenant-level data from MTS 500 that may require one or more queries to data storage 512. In some embodiments, MTS 500 automatically generates one or more SQL statements (the SQL query) designed to access the desired information. In some cases, user systems 550 may generate requests having a specific format corresponding to at least a portion of MTS 500. As an example, user systems 550 may request to move data objects into a particular environment 524 using an object notation that describes an object relationship mapping (e.g., a Javascript object notation mapping) of the specified plurality of objects.

The various techniques described herein and all disclosed or suggested variations, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. One such environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (Saas) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together to provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Where appropriate, it is also contemplated that claims drafted in one format or statutory type (e.g., apparatus) are intended to support corresponding claims of another format or statutory type (e.g., method).

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

1. A non-transitory computer-readable medium having program instructions stored thereon that are capable of causing a computer system to perform operations comprising:
receiving, for just-in-time (JIT) compilation by a JIT compiler, program instructions defined in a procedural language of a database system, wherein the received program instructions include one or more function calls that pass a data structure as an input parameter for one or more functions;
analyzing, by the JIT compiler, a call stack associated with the one or more function calls to determine whether to pass the data structure in a first format or a second format; and
based on the analyzing, inserting, by the JIT compiler, one or more operators into the received program instructions to cause the data structure to be passed in the determined format to the one or more functions in response to execution of the program instructions by the database system.

2. The non-transitory computer-readable medium of claim 1, wherein the analyzing further comprises:
building, by the JIT compiler, a syntax tree, wherein the syntax tree identifies, for each of the one or more function calls, whether that function performs read or write operations on the data structure; and
examining, by the JIT compiler, the read and write operations identified in the syntax tree.

3. The non-transitory computer-readable medium of claim 1, further comprising:
after compilation of the received program instructions, executing the compiled program instructions, wherein executing the compiled program instructions includes executing the one or more operators to cause the data structure to be passed in the determined format.

4. The non-transitory computer-readable medium of claim 1, wherein the one or more operators inserted include an operator that deletes the data structure after determining, based on the call stack, that the data structure is no longer needed.

5. The non-transitory computer-readable medium of claim 1, wherein the first format is a flattened format and the second format is an expanded format, and wherein the one or more operators inserted into the received program instructions convert the data structure from the flattened format to the expanded format upon detecting a write operation in a subsequent function call.

6. The non-transitory computer-readable medium of claim 5, wherein the conversion of the data structure from the flattened format to the expanded format is performed by calling an expansion function that executes the conversion prior to a transition between function calls.

7. The non-transitory computer-readable medium of claim 5, wherein the flattened format stores the data structure in a contiguous block of memory, and wherein the expanded format stores the data structure in a tree structure using pointers to one or more memory locations.

8. A non-transitory computer-readable medium having program instructions stored thereon that are capable of causing a computer system to perform operations comprising:
receiving, for just-in-time (JIT) compilation by a JIT compiler, program instructions defined in a procedural language of a database system, wherein the received program instructions include one or more function calls that pass a data structure as an input parameter for one or more functions;
analyzing, by the JIT compiler, a call stack associated with the one or more function calls to determine whether to pass the data structure in a first format or a second format;
based on the analyzing, inserting, by the JIT compiler, one or more bytecode instructions into a compiled version of the received program instructions to cause the data structure to be passed in the determined format to the one or more functions in response to execution of the compiled program instructions by the database system; and
executing the compiled program instructions, wherein executing the program instructions includes executing the inserted bytecode instructions.

9. The non-transitory computer-readable medium of claim 8, wherein the analyzing further comprises:
building a syntax tree, wherein the syntax tree identifies for each of the one or more function calls whether that function performs read or write operations on the data structure; and
examining the read and write operations identified in the syntax tree.

10. The non-transitory computer-readable medium of claim 8, wherein the operations further comprise:
determining, based on a return from a function call, that no subsequent function in the call stack performs a read or write operation on the data structure; and
inserting a deletion operation within the bytecode instructions that deletes the data structure.

11. The non-transitory computer-readable medium of claim 8, wherein the first format is a contiguous block of memory and the second format is a non-contiguous block of memory, and wherein the one or more bytecode instructions inserted into the compiled program instructions convert the data structure from the contiguous block of memory to the non-contiguous block of memory upon detecting a write operation in a subsequent function call.

12. The non-transitory computer-readable medium of claim 8, wherein the first format of the data structure is a flattened format represented as an array of elements.

13. The non-transitory computer-readable medium of claim 8, wherein the first format is a flattened format and the second format is an expanded format, and wherein the data structure is passed by reference between function calls in the flattened format if a write operation is not detected.

14. A computer-implemented method comprising:
receiving, for just-in-time (JIT) compilation by a JIT compiler, program instructions defined in a procedural language of a database system, wherein the program instructions include one or more function calls that pass a data structure as an input parameter for one or more functions;
analyzing, by the JIT compiler, a call stack associated with the one or more function calls to determine whether to pass the data structure in a first format or a second format; and
based on the analyzing, inserting, by the JIT compiler, one or more operators into the program instructions to cause the data structure to be passed in the determined format to the one or more functions in response to execution of the program instructions by the database system.

15. The computer-implemented method of claim 14, wherein the analyzing further comprises:
building a syntax tree, wherein the syntax tree identifies for each of the one or more function calls whether that function performs read or write operations on the data structure; and
examining the read and write operations identified in the syntax tree.

16. The computer-implemented method of claim 14, further comprising:
executing the program instructions, wherein executing the program instructions includes executing the one or more operators to cause the data structure to be passed in the determined format.

17. The computer-implemented method of claim 14, wherein the one or more operators inserted include an operator that deletes the data structure after determining, based on the call stack, that the data structure is no longer needed.

18. The computer-implemented method of claim 14, wherein the first format is a flattened format and the second format is an expanded format, and wherein the one or more operators inserted into the program instructions convert the data structure from the flattened format to the expanded format upon detecting a write operation in a subsequent function call.

19. The computer-implemented method of claim 18, wherein the conversion of the data structure from the flattened format to the expanded format is performed by calling an expansion function that executes the conversion prior to a transition between function calls.

20. The computer-implemented method of claim 18, wherein the flattened format stores the data structure in a contiguous block of memory, and wherein the expanded format stores the data structure in a tree structure using pointers to one or more memory locations.
